(19) United States
(12) Patent Application Publication
(10) Pub. No.: US 2006/0271378 A1
(43) Pub. Date: Nov. 30, 2006

(54) System and method for designing a medical care facility

(76) Inventor: Andrew Phelps Day, Pewaukee, WI (US)

Correspondence Address: THE SMALL PATENT LAW GROUP LLP, 611 OLIVE STREET, SUITE 1611, ST. LOUIS, MO, 63101, US

(21) Appl. No.: 11/136,978

(22) Filed: May 25, 2005

(51) Int. Cl. G06Q 99/00

(52) U.S. Cl. 705/1

(57) ABSTRACT

Systems and methods for designing a medical care facility are provided. The method includes receiving usage data relating to a medical care facility and selecting at least one metric for evaluating a medical care facility design. The method further includes processing with a processor the usage data to determine a value for the at least one metric corresponding to the medical care facility design.

### BACKGROUND OF THE INVENTION

This invention relates generally to medical care facilities, and more particularly, to systems and methods for designing medical care facilities.

The retooling of the healthcare industry includes the design and construction of new medical care facilities. This process of design and construction includes not only architectural designing and planning for new construction (e.g., aesthetics), but ensuring that the new facilities accommodate extra capacity of patients and meet other requirements or standards, such as, seismic requirements.

The typical process for designing a medical care facility generally includes planning the design, which is usually based on historical data and basic demographic growth projections of the number of patients in each of a particular category, for example, based on the type of procedure for which the patient is coming to the medical care facility. Using the numbers, an architect, based on his or her experience in designing buildings, which may or may not include designing medical care facilities, determines the layout of the medical care facility, including the number and type of rooms, etc. After designing a layout, the medical care facility is developed including making sure the layout complies with applicable standards and is acceptable to, for example, the health care provider building the facility.

The focus on the design and development of medical care facilities is typically on the size to accommodate increased numbers of patients and the aesthetics of the physical building to be appealing to, for example, the current health care provider building the facility and potential future health care providers interested in building a facility. However, although the new facility is able to accommodate additional patients and may be aesthetically pleasing, because the facility is typically larger and designed based the experience of the architect, such as, based on other hospitals designed and constructed by that architect, the final design may be less efficient, for example, provide less efficient throughput of patients. Thus, a medical care facility is designed and constructed that results in lost time and increased costs.

### BRIEF DESCRIPTION OF THE INVENTION

In an exemplary embodiment, a method for designing a medical care facility is provided. The method includes receiving usage data relating to a medical care facility and selecting at least one metric for evaluating a medical care facility design. The method further includes processing with a processor the usage data to determine a value for the at least one metric corresponding to the medical care facility design.

In another exemplary embodiment, a system for evaluating the design of a medical care facility is provide that includes a computing component configured to receive at least one of usage data, metrics data and workflow data corresponding to a medical care facility design and to process the data to generate a metric value output. The system further includes a user interface configured to receive user inputs relating to processing the received data and a display for displaying the metric value output.

In yet another exemplary embodiment, a computer program embodied on a computer readable medium for evaluating the design of a medical care facility is provided. The computer program includes a code segment that receives usage data and then determines based on a user input a metric value to calculate corresponding to medical care facility design and processes the received usage data to calculate the metric value corresponding to the medical care facility design.

### BRIEF DESCRIPTION OF THE DRAWINGS

FIG. 1 is a block diagram of an exemplary system for implementing various embodiments of the present invention.

FIG. 2 is a flowchart of a method for designing a medical care facility in accordance with an exemplary embodiment of the invention.

FIG. 3 is a block diagram illustrating a process for generating flow patterns in accordance with various embodiments of the invention.

FIG. 4 is a table illustrating an options matrix generated in accordance with various embodiments of the invention.

FIG. 5 is a flow pattern table generated in accordance with various embodiments of the invention.

FIG. 6 is a service line chart generated in accordance with various embodiments of the invention.

FIG. 7 is a medical care facility design layout generated in accordance with various embodiments of the invention.

FIG. 8 is flowchart illustrating flow data generated in accordance with various embodiments of the invention.

FIG. 9 is another flowchart illustrating flow data generated in accordance with various embodiments of the invention.

FIG. 10 is a volume weighted service line chart generated in accordance with various embodiments of the invention.

FIG. 11 is a flowchart of a design optimization method in accordance with various embodiments of the invention.

FIG. 12 is a block diagram of a user interface constructed in accordance with various embodiments of the invention.

FIG. 13 is a block diagram of another system constructed in accordance with various embodiments of the invention for use in designing a health care facility.

### DETAILED DESCRIPTION OF THE INVENTION

Exemplary embodiments of systems and methods for designing medical care facilities using various metrics to perform workflow analysis of the designs are described in detail below. A technical effect of the systems and methods described herein include at least one of increasing the overall efficiency of the operation of a medical care facility to be developed. Using workflow analysis, an iterative design process is implemented in which metrics are measured to in order to increase the efficiency of the medical care facility based on the design layout.

Various embodiments of the present invention provide an iterative evaluation process that uses metrics to design a medical care facility. It should be noted that when reference is made herein to a medical care facility, this refers to any type of facility providing medical or health care, and may include, for example, a hospital (or a portion thereof), an outpatient facility, a mobile facility (e.g., a mobile trailer), among others.

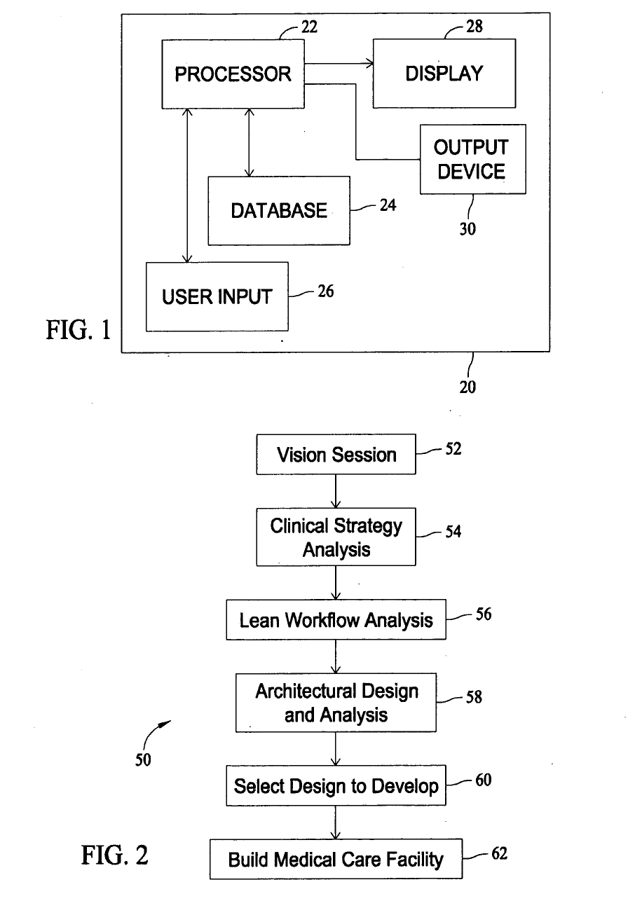

In general, and as shown in FIG. 1, various embodiments of the present invention may be implemented in a system 20 having a processor 22 for accessing a database 24 to obtain data for use in designing a medical care facility. The processor 22 is also connected to a user input 26 for receiving, for example, user requests and commands for information. The processor 22 then processes requests from the user input 26 and displays the results on a display 28 or provides the results to an output device 30, such as, for example, a printer.

In various embodiments of the present invention, the database 24 includes usage data for use is designing a medical care facility. The usage data includes, but is not limited to, inpatient volume data (e.g., DRG data), outpatient procedure volume data (e.g., APC/CPT data), departmental or equipment use data from log sheets or Hospital Information Systems (HIS), etc. In general, the usage data includes information relating to the operations of a medical care facility and may be stored, for example, in the form of billing data for a medical care facility. Further, the usage data may relate to different medical resources, including, but not limited to, patients, families of patients, clinicians (e.g., nurses, doctors and technicians), equipment and functional spaces, etc. The usage data may be acquired from different sources or systems.

The various embodiments or components, for example, the system 20 or other processors, may be implemented as part of a computer system, which may be separate from or integrated with a server or other network. The computer system may include a computer having the processor 22, an input device, such as the user input 26, a display 28 and an interface, for example, for accessing the Internet or other systems on a network. The computer may include a microprocessor. The microprocessor may be connected to a communication bus. The computer also may include a memory, for example, configured as the database 24. The memory may include Random Access Memory (RAM) and/or Read Only Memory (ROM). The computer system further may include a storage device, which may be a hard disk drive or a removable storage drive such as a floppy disk drive, optical disk drive, and the like to store, access and transfer, for example, the usage data. The storage device may also be other similar means for loading computer programs or other instructions into the computer system.

As used herein, the term “computer” may include any processor-based or microprocessor-based system including systems using microcontrollers, reduced instruction set circuits (RISC), application specific integrated circuits (ASICs), logic circuits, and any other circuit or processor capable of executing the functions and methods described herein. The above examples are exemplary only, and are thus not intended to limit in any way the definition and/or meaning of the term “computer.”

The computer system executes a set of instructions that are stored in one or more storage elements, in order to process input data, such as, for example, usage and workflow data. The storage elements also may store data or other information as desired or needed. The storage element may be in the form of an information source or a physical memory element within the processing machine.

The set of instructions may include various commands that instruct the computer as a processing machine to perform specific operations such as the methods and processes of the various embodiments of the invention described below. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

In general, a method 50 for designing a medical care facility is shown in FIG. 2. The method 50 includes a vision session 52 in which one or more of the following are determined for the medical care facility to be designed:

1. A vision defining the overall concept for the medical care facility. This may include receiving input from the medical care provider, employees of the medical care provides, patients, etc. regarding what is important or needed in the medical care facility.

2. A mission for the medical care facility, which may be defined in part by the vision.

3. Priorities for the medical care facility. This may include priorities as set forth by the individuals when defining the vision. For example, priorities for types of medical care to be offered, etc. may be established.

4. Focus for the design of the medical care facility. This may include defining the specific details of particular interest or concern for the design.

Thereafter, a clinical strategy analysis is performed at 54. This may include a market analysis, a current state of technology assessment, a future state of technology adoption plan by service line defined by types of procedures (e.g., a clinical technology roadmap subdivided by procedure), projections for volumes, ALOS and IP/OP practice pattern shifts. Each of the components of the analysis may be performed using know programs or entities or data/information derived therefrom. For example, modeling tools such as MedModel and/or ProModel available from ProModel Corporation of Orem, Utah, may be used to model the operations of the medical care facility. However, the various embodiments are not limited to a particular modeling tool and may be modified to include other modeling tools or processes, such as, for example, the ARENA modeling tool available from Rockwell Software Incorporated of Sewickley, Pa. It should be noted that a company such as SG2 (of Evanston, Ill.) may be used to generate data/information to predict future trends, such as future applications/technologies to provide clinical strategy mapping. For example, the data may be based on emerging clinical technologies and projections of when these emerging technologies are likely to be adopted by, for example, a particular health care provider that is designing a medical care facility. The data/information also may be based on the risk or technology adoption profile of the particular health care provider.

At 56, a lean workflow analysis is performed. In general, the lean workflow analysis may be performed using a computer to provide Pareto analysis as is known to prioritize flow streams (e.g., workflow streams in the medical care facility), map volume weighted flow pathways within the medical care facility, measure current state information and adjust for lean and technology shifts, for example, based on the prediction of future trends. This lean workflow analysis may be used to generate one or more reports regarding the present and future work flows for the medical care facility to be constructed.

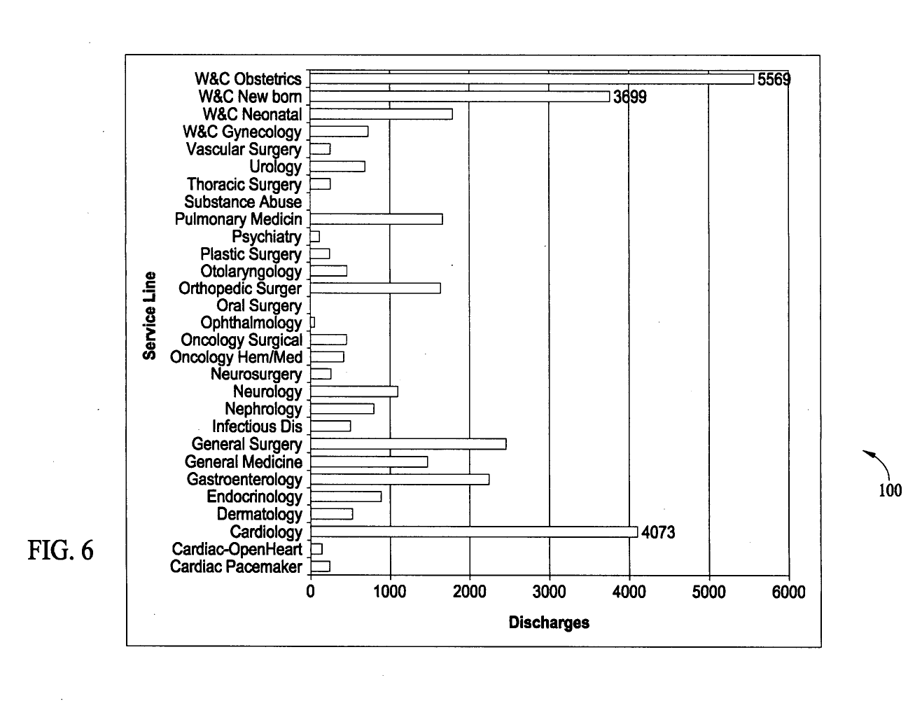

For example, a Pareto analysis, as is know, may be performed based on service lines (e.g., cardiology, orthopedics, neurology, dermatology, endocrinology, gastroenterology, general medicine, general surgery, oncology, pediatrics, urology, women's health, etc.) using billing data from a billing system of the medical care facility. A service line chart 100 shown in FIG. 6 and showing, for example, the number of discharges per service line may be generated and displayed using, for example, a spreadsheet or similar program, such as for example, Microsoft EXCEL® available from Microsoft Corporation of Redmond, Wash. or Minitab® available from Minitab, Inc. of State College, Pa. From the service line chart 100, high volume pathways may be determined. For example, as shown in FIG. 6, the high volume pathways include Women's and Children's (W&C) Obstetrics, Cardiology, W&C Newborn Pulmonary Medicine, General Surgery and Gastroenterology. Using a Pareto analysis of high volume pathways, for example, clinician and/or patient pathways, a determination may be made as to the higher priority service lines. The design of the medical care facility may then focus on these high priority service lines.

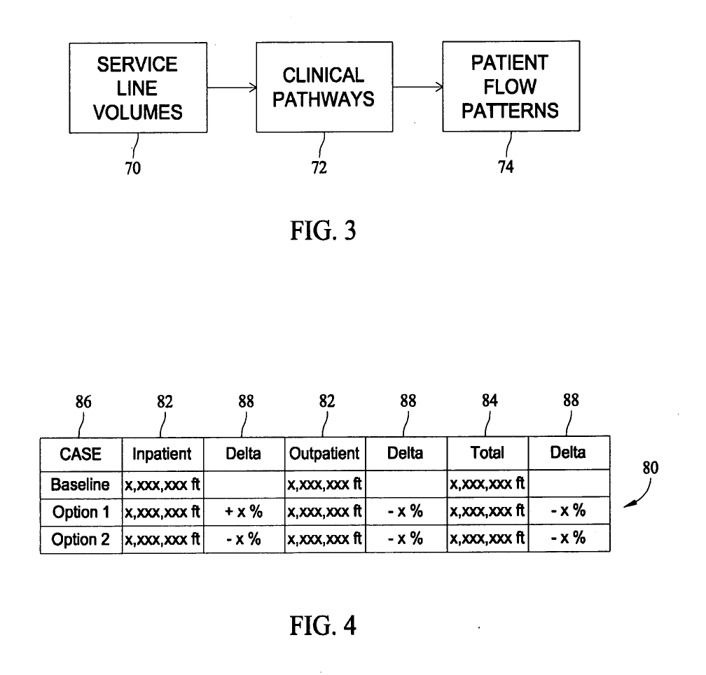

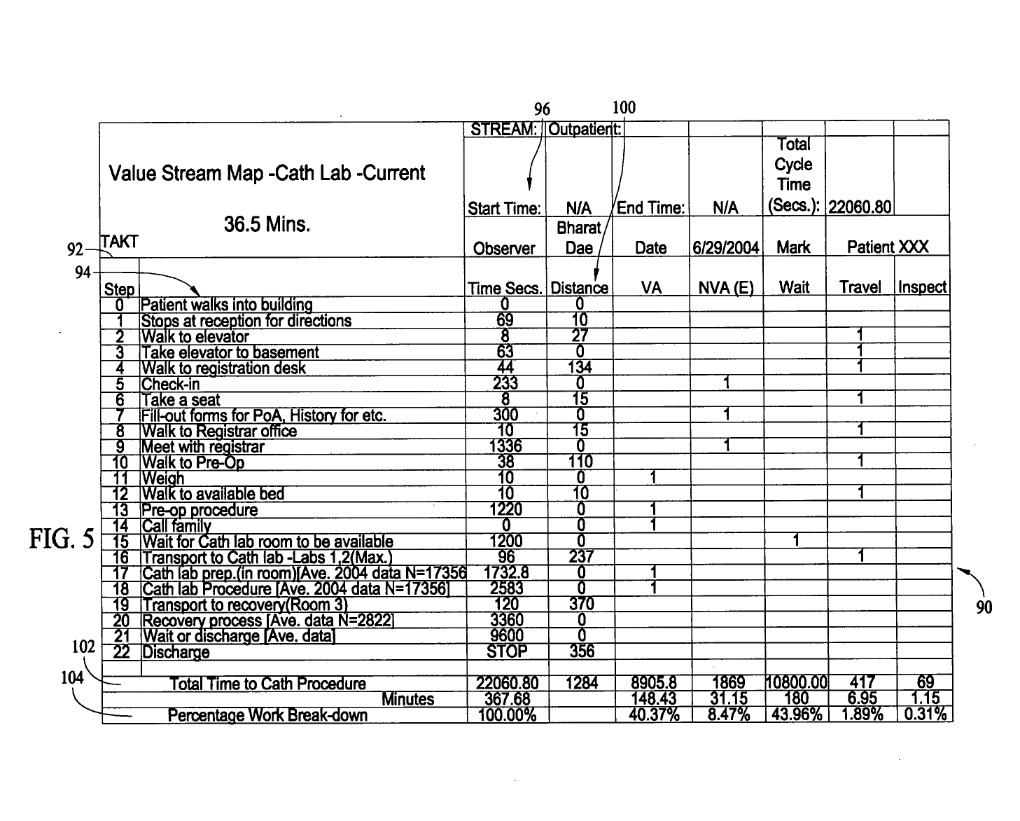

Essentially, and as shown in FIG. 3, service line volumes data 70 is acquired and used to generate clinical pathways data 72. Then, using the clinical pathways data 72, patient flow patterns data 74 is generated. It should be noted that the service line volumes data 70 may include service line volumes predictions for future work flow. This prediction may be based on, for example, increase in population, increase in age of the population or projected increases in certain types of procedures. The prediction also may be based on, for example, clinical or technological predicted advances. Thus, flow patterns for each of the services is generated, which may include, for example, flow patterns for each service lines for each of clinicians, patients and families. These flow patterns generally define the different steps for each service line, such as, for example, from when a patient enters the medical care facility to when a patient is discharged, or from a clinician's first contact with a patient for a procedure to when the procedure is complete. For example, as shown in FIG. 5, a flow pattern table 90 may be generated, such as, for a catheter laboratory procedure, and which indicates the steps of the procedure in a Step column 92 and a Description column 94. The corresponding time for each step based on a start time and an end time is provided in a Time column 96. Additionally, a distance traveled for each step also is provided in a Distance Traveled column 100. The distance traveled data may be obtained from, for example, the layout of the particular area for that procedure. Further, the distance traveled may be converted to a time traveled with a total time traveled provided in a Total Time row 102 and a percentage value in a Percentage row 104. Additional information also may be provided, for example, value added (VA) data and non-value added data (NVA) in a VA column 101 and an NVA column 103, respectively. Further, and for example, wait time information may be provided in a Wait column 105, travel time information may be provided in a Travel column 107 and inspection time information may be provided in an Inspection column 109.

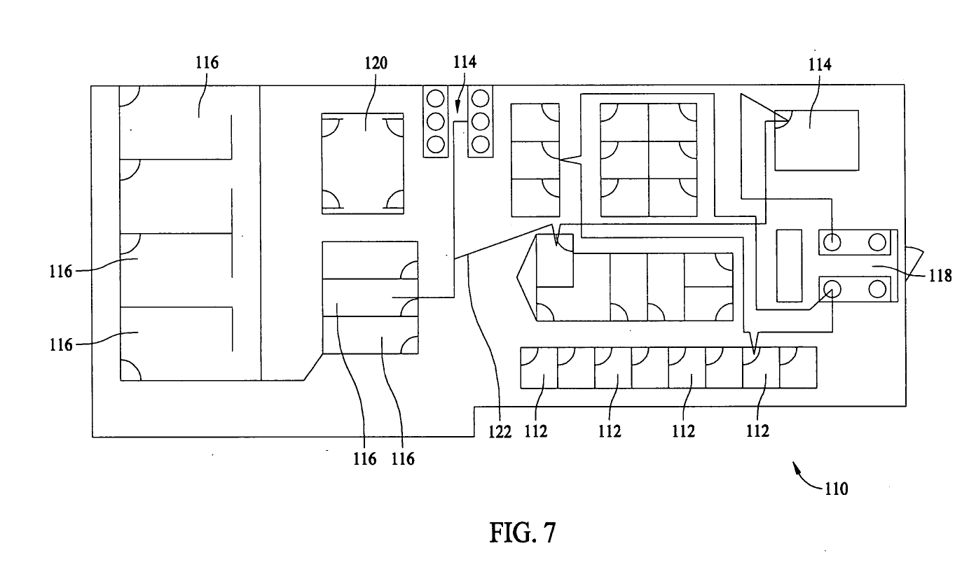

Additionally, and as shown in FIG. 7, a medical care facility design layout 110 showing flow patterns, also referred to as a spaghetti diagram, may be generated and used to generate the flow pattern table 90. The spaghetti diagram may be displayed using, for example, a Computer Aided Design (CAD) program such as AutoCAD® available from Autodesk, Inc. of San Rafael, Calif. For example, the layout 110 may show various different types of rooms, such as examination rooms 112, laboratory rooms 114, procedure rooms 116, waiting rooms 118, meeting rooms 120, etc. Using the layout 110, a traveled path or flow path 122 for a particular procedure or process (e.g., obstetric (OB) exam/procedure) may be diagramed, thereby allowing the determination of the distance traveled for each of the various steps of the procedure. Additionally, such a layout 110 allows for determining additional information, such as, for example, different options, duplicate use of space, etc. A CAD type program may be used, for example, to display the layout 110.

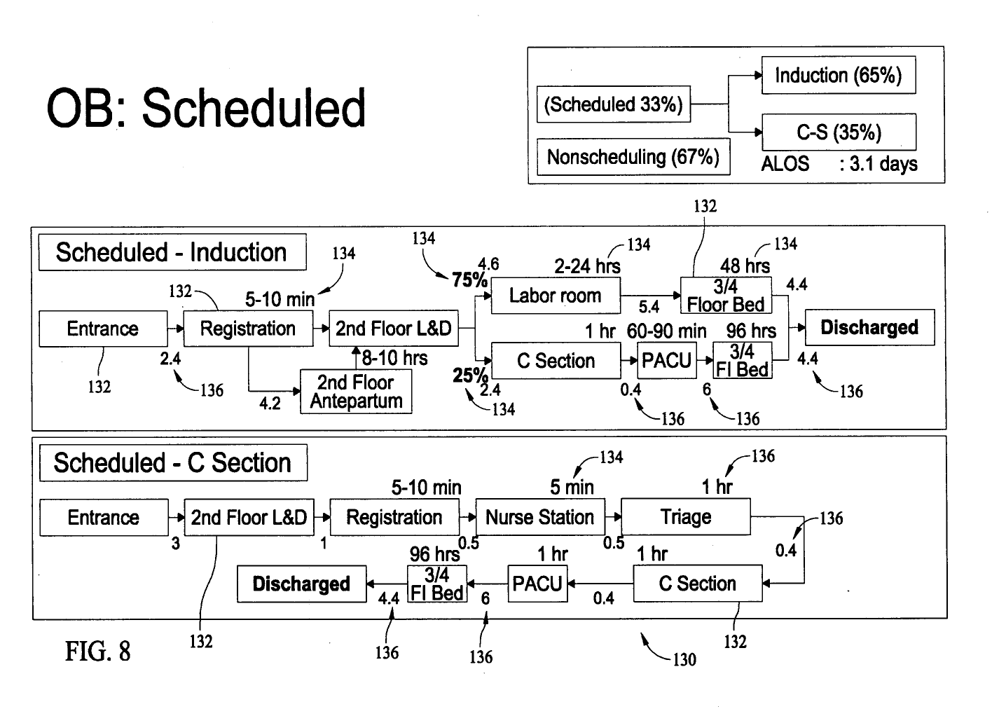

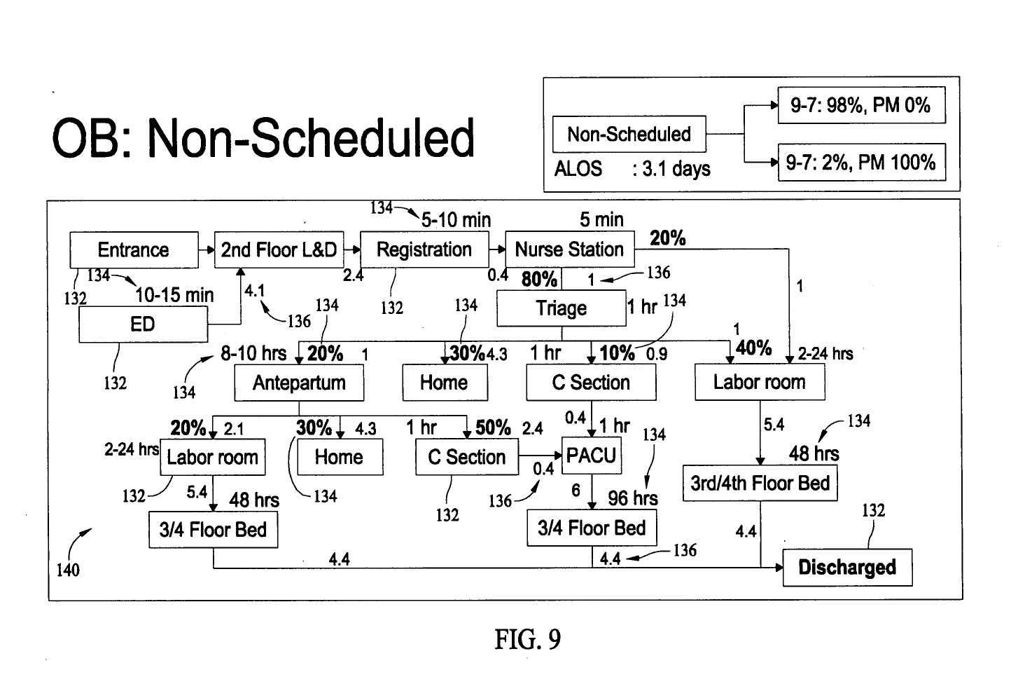

Additionally, and as shown in FIGS. 8 and 9, flowcharts for the steps for a procedure or exam may be generated showing time and distance information based on a current layout 110. These flowcharts may be displayed using, for example, programs such as Microsoft Powerpoint® or VISIO® both available from Microsoft Corporation of Redmond, Wash. In the example shown, FIG. 8 illustrates a flowchart 130 of a scheduled OB exam/procedure and FIG. 9 illustrates a flowchart 140 of an unscheduled OB exam. Each of the flowcharts 130 and 140 show the steps 132 for the exams/procedures and the different possible paths, for example, C-section versus labor room delivery. Further, an indication of the likelihood of the various paths is indicated by a percentage value 134, for example, for a scheduled induction seventy-five percent of the time the patient goes to the labor room for vaginal delivery and twenty-five percent of the time the patient goes to the operating room for a C-section (e.g., emergency C-section). Further, for each of the steps 132 a corresponding time value 134 is provided indicating the average or typical amount of time for that step 132. This time value 134 may be a range. Also, between each of the steps 132 an indication is provided as to the distance between the locations (if different) based on the current layout 110 and is set forth as a distance value 136. Using the flowcharts 130 and 140, different metrics may be analyzed, for example, distance traveled and time for the entire procedure or workflow, and/or for particular steps within the procedure. Additionally, pathway weighted information based on patient volume or branching percentages may be provided in a weighted information portion 133.

It should be noted that the data for the flowcharts 130 and 140 and for generating the percentage values 134, etc., in an exemplary embodiment, are derived from the usage data. This may include using historical data over a predetermined period of time.

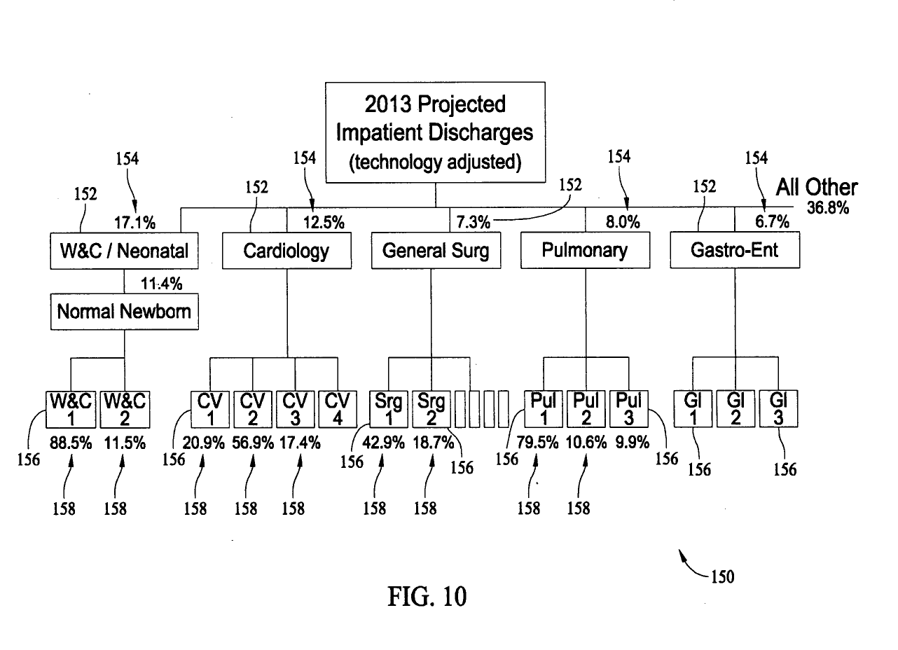

Further, a volume weighted service line chart 150 as shown in FIG. 10 may be generated, which in an exemplary embodiment, shows percent of overall procedures. It should be noted that the volume weighted service line chart 150 may indicate current flow or predicted flow, based on, for example, inpatient discharges adjusted for predicted technology changes as described above. Specifically, the volume weighted service line chart 150 shows each of the high volume service lines 152 with a corresponding percentage value 154, which in this example, is percentage of inpatient discharges. Additionally, the volume weighted service line chart 150 includes for each high volume service line 152 an indication of the percentage of procedures (expressed as a percentage value 158) for each of a plurality of rooms 156, for example, cardiology exam rooms (CV1-CV4), pulmonary exam rooms (Pul1-Pul3), etc.

Referring again to FIG. 2, after the lean flow analysis at 56, one or more architectural plans or layouts are designed and analyzed at 58. In an exemplary embodiment, the initial design or layout is based on design guidelines, which may include, flow patterns and prioritized adjacencies of key functional spaces as determined by the Pareto analysis. The design may be generated using for example, an architectural CAD program. Further, and as described in more detail herein, this process is an iterative process wherein one or more design layouts are analyzed using a plurality of metrics in an iterative workflow analysis and which may include, for example, analysis of interdepartmental patient flow including patient, clinician, family or visitor flow. In an exemplary embodiment, distance traveled by clinicians is the primary metric and distance traveled by patients and families is a secondary or optional metric. The analysis may include the use of previously determined workflow data including, for example, distance traveled between one of key medical equipment, departments, rooms and functional spaces, cycle times of clinical procedures and non-clinical process steps, frequencies or probabilities of occurrence of different clinical steps for patients with different diseases and/or symptoms, etc.

The iterative process is continued until a predetermined level or threshold for a metric is achieved, for example, when the number of feet traveled by clinicians for a year is lower than a maximum threshold. It should be noted that the iterative process may be performed for the entire design layout for the medical care facility or a portion thereof, such as, for example, a confined space. The confined space may be defined, for example, as a healthcare campus, hospital wing, individual department, a floor of the medical care facility, a particular facility, such as an ambulatory facility, a particular building, such as, a medical office building or an imaging center, and combinations thereof. Further, this process may be performed on a plurality of different designs or options to generate an options matrix 80 as shown in FIG. 4, setting forth the distance traveled for each of the options and change from a baseline (e.g., initial design). For example, a separate Inpatient travel distance column 82, Outpatient travel distance column 82 and Total travel distance column 84 may be provided having travel distances for each of a plurality of designs identified in a Case column 86. A corresponding delta column 88 for each of the distance traveled columns is provide to indicate a change from, for example, a baseline for each of the options. Although the options matrix 80 is shown for patient travel, different matrices for clinician and family travel may be provided is a similar manner. The options matrix 80 may be generated for each of the iterations.

Once the predetermined level or threshold for the metric is achieved, the layout or plan meeting that predetermined level or threshold is selected for development at 60. This includes know processes of developing the structural and other aspects of the design, for example, the civil engineering development of the design. This process may include selecting features for the medical care facility that do not impact the metrics, such as, for example, wiring, paint, etc. It should be noted that if a design change is made that may affect the defined metric(s), the iterative process at 58 may be repeated.

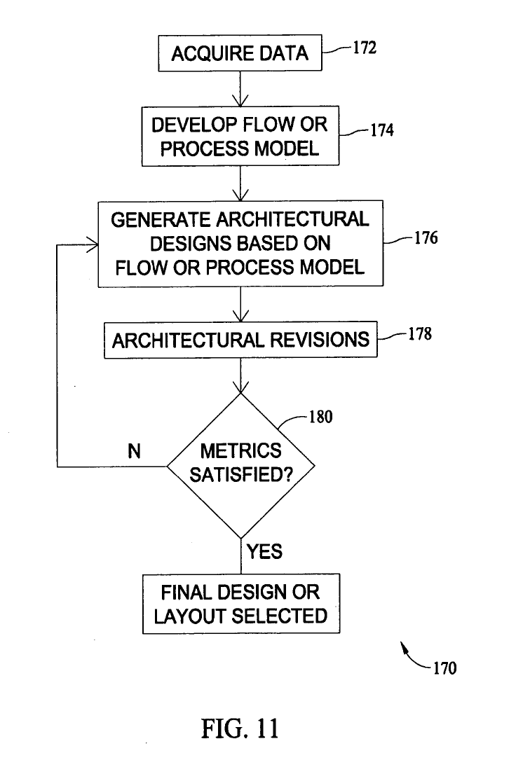

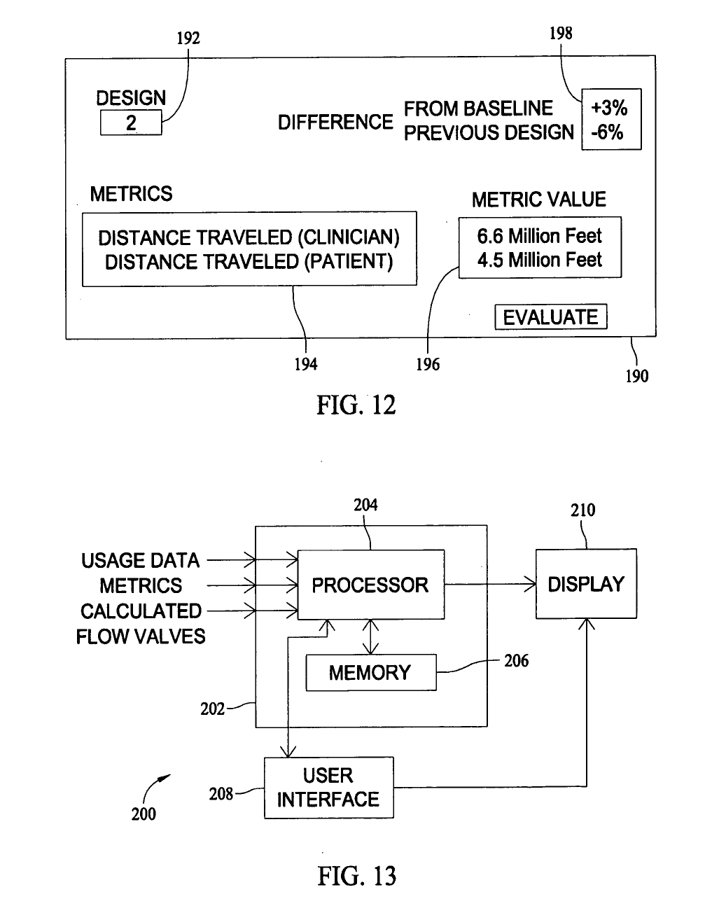

In an exemplary embodiment of the invention, the lean work flow analysis at 56, design and analysis of one or more architectural plans or layouts at 58, and selection of plan or layout at 60 together are defined by a design optimization method 170 shown in FIG. 11. The design optimization method 170 provides for optimizing the workflow of a particular layout or design for a medical care facility using an iterative process. More particularly, at 172 data is acquired, and specifically, usage data and workflow data is acquired. This may include acquiring process mapping data, service line volume data, Pareto data, etc., as described in more detail above. For example, this data may be acquired from a hospital billing system. Thereafter, at 174, a flow or process model is developed. This includes, for example, using metrics based on the acquired data to develop pathways, such as clinician and patient pathways to simulate current and future volumes. In various embodiments, and as described above, the process model may be developed based on one of current or future flow.

Thereafter, at 176, one or more architectural designs defined by one or more layouts are generated based on the flow or process models. This may include generating architectural layouts for different variations or options for a design for a proposed medical care facility. The number of rooms, types of rooms, positioning of rooms, etc. is initially determined based on the flow or process models developed at 174. Workflows are then simulated for each of the layouts or designs at 176. This may include, for example, simulating different designs or comparing different options (e.g., different positioning of rooms) to provide a comparative analysis. It should be noted the designs or layouts may be provided by the same or different entities (e.g., different architect/engineer firms). This process may also include incorporating predicated changes in flow, as well as, predicted changes in technology as described above.

Architectural revisions are then made to the layouts or designs at 178. This may include, for example, changing the number of a particular type of rooms, changing the location of particular rooms, changing the arrangement of particular rooms, etc. This process results in a revised design or layout based on the simulated workflows at 176. Thereafter, the revised layout or plan is evaluated to determine at 180 if the overall plan or the portion changed satisfies a predetermined metric, which in various embodiments, is defined by a threshold level. For example, the metric may be distance traveled, time of travel, number or trips, time in motion, etc. as described above. Further, these metrics may be evaluated for different service lines, workflows, or individuals, for example, for clinicians, patients, families, visitors, etc. The threshold level may be based on, for example, a desired change from a baseline level, a user defined value, etc. If the one or more metrics are not satisfied at 180 then new architectural designs are generated at 176, for example, based on changes to particular service lines having an excessive distance traveled metric. If the one or more metrics are satisfied at 180, then at 182 a final design or layout is selected.

Referring again to FIG. 2, after the design and/or layout is finalized, the medical care facility is built at 62. This includes the construction of the physical structure as is known. Thus, the method 50 in combination with the design optimization method 170 results in the design, development and construction of a medical care facility with improved efficiency based on workflow patterns and analysis.

The various embodiments and methods may be implemented using any type of computer or computing machine and may be provided in connection with a user interface. For example, in one exemplary embodiment, a user interface 190 as shown in FIG. may be provided. The user interface may include a Design field 192 for selecting from one of a plurality or designs or layouts (or revisions thereof), for example, from a pull down menu. The user interface 190 also includes a Metrics field 194 for selecting one or more metrics for evaluation. The Metric values field 196 displays the current metric value, which may be compared to a threshold value. Additionally, a difference value from a baseline value and a previous design for one or more or the metrics is displayed in the Difference field 198. It should be noted that the user interface 190 may display information based on data or information generated and provided from the various embodiments and which may include using different processes or programs as described herein.

Thus, in one embodiment, a system 200 may be provided for implementing one or more of the various embodiments of the invention. The system 200 includes a processor for receiving and processing information, such as usage data, workflow data, metrics, calculated flow values, etc. This information may be weighted, for example, based on percentages, etc. This information may be received from other computers or machines, for example, from a different system (e.g., billing system) or from a connected or networked system. The system includes a computing component 202 having a processor 204 for processing the received information. For example, in an exemplary embodiment, the processor 204 is configured or programmed to implement one or more of the various methods described herein. The computing component 202 also includes a memory 206 for storing, for example, the received information or intermediate processed data. The system 200 also includes a user interface 208, which in an exemplary embodiment is the user interface 190. The system further includes a display 210 for displaying the processed results, for example, a metric value output. It should be noted that the components described herein may be implemented as modules, with each performing or defining particular actions or processes.

Thus, the various embodiments of the present invention provide a system and method for designing a medical care facility. The various embodiments obtain usage and workflow data and use metrics to evaluate one or more designs to select, for example, an optimized design based on specific service lines and workflows.

While the invention has been described in terms of various specific embodiments, those skilled in the art will recognize that the invention can be practiced with modification within the spirit and scope of the claims.

What is claimed is:

1. A method for designing a medical care facility, said method comprising:
receiving usage data relating to a medical care facility;
selecting at least one metric for evaluating a medical care facility design; and
processing with a processor the usage data to determine a value for the at least one metric corresponding to the medical care facility design.

2. A method in accordance with claim 1 further comprising developing a flow model based on the usage data to generate an initial medical care facility design.

3. A method in accordance with claim 2 further comprising using at least one of projected usage data and projected technology data to develop the flow model.

4. A method in accordance with claim 2 further comprising using weighted usage data to develop the flow model.

5. A method in accordance with claim 1 further comprising simulating work flows based on the usage data and corresponding to the medical care facility design.

6. A method in accordance with claim 1 further comprising modifying the medical care facility design based on the processed usage data.

7. A method in accordance with claim 1 further comprising iteratively modifying the medical care facility design and processing the usage data until a predetermined threshold level for the metric is reached.

8. A method in accordance with claim 1 wherein the metric comprises at least one of distance traveled, time of travel, number of trips, and time in motion for at least one of clinicians, patients and families.

9. A method in accordance with claim 1 wherein the usage data comprises at least one of inpatient volume data (e.g., DRG data), outpatient procedure volume data (e.g., APC/CPT data), and departmental or equipment use data from log sheets or Hospital Information Systems (HIS).

10. A method in accordance with claim 1 further comprising selecting a plurality of service lines in connection with which to process usage data corresponding thereto and prioritizing service lines based on the usage data.

11. A method in accordance with claim 1 further comprising generating a plurality of medical care facility designs based on the usage data.

12. A system for evaluating the design of a medical care facility, said system comprising:
a computing component configured to receive at least one of usage data, metrics data and workflow data corresponding to a medical care facility design and to process the data to generate a metric value output;
a user interface configured to receive user inputs relating to processing the received data; and
a display for displaying the metric value output.

13. A system in accordance with claim wherein the computing component comprises a memory connected to the processor.

14. A system in accordance with claim wherein the user interface comprises a plurality of user definable fields including at least one of a Design field, Metrics field, Metrics value field and Difference field.

15. A system in accordance with claim wherein the metric data comprises at least one of distance traveled, time of travel, number of trips, and time in motion for at least one of clinicians, patients and families.

16. A system in accordance with claim wherein the usage data comprises at least one of inpatient volume data (e.g., DRG data), outpatient procedure volume data (e.g., APC/CPT data), and departmental or equipment use data from log sheets or Hospital Information Systems (HIS).

17. A system in accordance with claim wherein the processor is configured to iteratively process a plurality of input data corresponding to a plurality of medical care facility designs to generate a difference values for at least one metric.

18. A computer program embodied on a computer readable medium for evaluating the design of a medical care facility, said program comprising a code segment that receives usage data and then:
determines based on a user input a metric value to calculate corresponding to medical care facility design; and
processes the received usage data to calculate the metric value corresponding to the medical care facility design.

19. A computer program in accordance with claim 18 further comprising a code segment that:
compares metric values from a plurality of medical care facility designs and calculates a difference value for the metric corresponding to each of the medical care facility designs.

20. A computer program in accordance with claim 18 wherein the metric value corresponds to at least one of distance traveled, time of travel, number of trips, and time in motion for at least one of clinicians, patients and families.
